(19) United States
(12) Patent Application Publication
(10) Pub. No.: US 2026/0102912 A1
(43) Pub. Date: Apr. 16, 2026

(54) METHOD FOR PROCESSING A WORKPIECE USING A ROBOT

(71) Applicant: 3D.aero GmbH, Hamburg (DE)

(72) Inventors: Sönke BAHR, Darmstadt (DE); Razvan-Andrei DRAGHICI, Hamburg (DE); Michael ERNST, Sulfeld (DE); Martin HARNISCH, Appen (DE)

(73) Assignee: 3D.aero GmbH, Hamburg (DE)

(21) Appl. No.: 19/357,196

(22) Filed: Oct. 14, 2025

(30) Foreign Application Priority Data
Oct. 14, 2024 (EP) 24206366.7

(51) Int. Cl. B25J 9/16; B25J 11/00; G05B 13/02

(52) U.S. Cl. CPC B25J 9/1664; B25J 11/0075; G05B 13/027

(57) ABSTRACT

A method for processing workpieces, in particular by painting, using a robot to simplify planning of the robot path or to make it fully automatic. The method can be used individually and together particularly advantageously. For example, not only can a painting strategy developed on at least one sample workpiece be transferred in a specifically adapted form to a large number of workpieces or workpiece sections of the same shape without having to position the workpieces exactly the same, but also deviations in the assembly of individual workpiece sections can be compensated.

### REFERENCE TO RELATED APPLICATIONS

This application claims the benefit of European Patent No. 24206366.7, filed on Oct. 14, 2024; the disclosure of which is incorporated herein by reference.

### TECHNICAL FIELD

The invention relates to a method for processing workpieces, in particular by painting, using a robot. The object is to simplify planning of the robot path or to make it fully automatic

### BACKGROUND ART

Various methods for classifying objects and for checking automatic planning methods are known from the prior art, in particular Pointnet (“PointNet: Deep Learning on Point Sets for 3D Classification and Segmentation” Charles R. Qi et al., arXiv:1612.00593v2, 10 Apr. 2017), Pointnet++ (“PointNet++: Deep Hierarchical Feature Learning on Point Sets in a Metric Space” Charles R. Qi et al. arXiv:1706.02413v1, 7 Jun. 2017) and Paintnet (“PaintNet: Unstructured Multi-Path Learning from 3D Point Clouds for Robotic Spray Painting”, Gabriele Tiboni et al., arXiv:2211.06930v3, 6 Dec. 2023, hereinafter Tiboni).

Methods are also known from the prior art for determining path sections that are necessary for the processing and then connecting them to form a robot path, for example from “Generating Optimized Trajectories for Robotic Spray Painting”, Daniel Gleeson, 1380 IEEE TRANSACTIONS ON AUTOMATION SCIENCE AND ENGINEERING, VOL. 19, NO. 3, JULY 2022, hereinafter Gleeson.

### SUMMARY OF THE INVENTION

In The present application presents several inventions that can be used individually and together particularly advantageously. For example, not only can a painting strategy developed on at least one sample workpiece be transferred in a specifically adapted form to a large number of workpieces or workpiece sections of the same shape, possibly scaled in size, without having to position the workpieces exactly the same, but also deviations in the assembly of individual workpiece sections can be compensated.

The path sections and/or the robot path can also be planned automatically and/or planned path sections and/or parts of a robot path can be efficiently improved and/or supplemented by manual planning of a section.

By means of a classification that distinguishes between flat and cubic bodies and also treats spatial bodies as a unit and not just separately from individual surfaces, it is possible, in contrast to the prior art, such as Tiboni, to plan path sections across several surfaces together, which can lead to significantly better painting results and/or savings in cycle time.

The object is achieved by a method for processing, in particular painting, of at least one workpiece, in particular according to the above method, in which the workpiece and/or at least one workpiece section and/or surface section, in particular in the first step, is classified, in particular semantically segmented, by means of a neural network, in particular using PointNet and/or PointNet++, in particular on a point basis, and, on the basis of the classification, a predetermined painting strategy is selected for each surface, workpiece section and/or surface section and used to generate the robot path, in particular path sections for generating the robot path.

The classification advantageously distinguishes at least between flat bodies and solid bodies on the one hand, and between closed bodies and those with recesses on the other, in particular distinguishes between closed surfaces, surfaces with recesses, cubic, cylindrical, shelf-shaped bodies and/or frame bodies, whereby in particular a consolidation of the point-based classification takes place in such a way that, in particular by means of segmentation, in particular region-based segmentation and/or segmentation by means of clustering, surfaces, workpiece sections and/or surface sections with a minimum size of the processing radius for the simultaneous processing by the robot, for example spraying radius and/or grinding radius.

The method advantageously comprises the processing of a plurality of identically shaped workpieces,
whereby in a first step, a robot path is created by means of a digital model of the or a first scan of the at least one workpiece, this being done in particular in such a way that the workpiece or a first of the plurality of workpieces is positioned by means of at least one support and/or holder and a point cloud of an outer contour of the first workpiece is created by means of a 3D scanner, whereby a convex and/or concave envelope of the point cloud is determined and whereby at least one robot path is created, in particular using the envelope.

In particular, in a second step, an in particular second workpiece of the plurality of workpieces is positioned by means of at least one support and/or holder, and a point cloud of an outer contour of the second workpiece is created by means of a 3D scanner or the 3D scanner.

In particular, the position and orientation of the digital model, in particular the point clouds of the at least one or first workpiece and the point cloud of the, in particular, second workpiece, are compared in order to determine a translational and/or rotational positional difference of the workpiece and/or at least one, in particular all, of its surfaces, workpiece sections and/or surface sections, and the robot path is transformed by the positional difference, this being done separately in particular for the surfaces, workpiece sections and/or surface sections.

In particular, the transformed robot path is traversed by means of at least one robot for processing the second workpiece, if necessary after further optimization, as known, for example, from Gleeson, and in particular the at least one or one or the plurality of workpieces is/are processed, in particular painted.

The second step is preferably repeated with further, in particular the plurality of the, workpieces.

By distinguishing between flat and cubic bodies and also handling three-dimensional bodies and not only individual surfaces, it is possible, in contrast to the prior art such as Tiboni, to plan path sections across several surfaces together, which can lead to significantly better painting results and/or savings in cycle time.

The splitting of the workpiece into surfaces, workpiece sections and/or surface sections can be defined or determined, for example, by a user input, by design data of the workpiece, by classification, edges of the workpiece and/or semantic segmentation.

Advantageously, the envelope is determined by means of Delaunay triangulation and/or by means of 3D alpha wrapping. This allows an envelope to be reliably determined.

In practice, the workpiece can be defined in particular at at least, in particular at exactly, two points, locations and/or suspension points of the workpiece. Advantageously, in particular by passing through the two points, a center plane can be determined which divides the workpiece into two parts, in particular approximately into halves in relation to the surface. The two parts can then be processed by two robots and the method can be applied in particular to each of the parts. This not only shortens the cycle time required for processing the workpiece, usually by more than half, but also improves accessibility for processing, which can contribute to a reduction in cycle time. This center plane can also be used for analysis by projecting the envelope perpendicularly to the center plane onto the center plane and using this projected envelope instead of or in addition to the envelope.

With particular advantage, the robot path is generated as path sections that are connected to each other, wherein the path sections are generated as straight lines in two spatial directions and/or in a plane, in particular averaged and/or approximately and/or completely perpendicular to the envelope and/or path envelope, on a path envelope around the envelope of the workpiece and/or the workpiece and/or at a predetermined and/or constant distance from the envelope and/or the workpiece, in particular from the respective surface, surface section and/or workpiece section to be planned. This can be achieved, for example, by laying and/or deflecting parallel beams and using only those parts of the beams that lie on the path envelope as path sections. In this case, the distance between the path envelope and the envelope/workpiece and/or the distance between the beams is predetermined in particular, depending on user input and/or the painting strategy. It may also be advantageous, in particular for more uniform processing and/or movement and/or to reduce the cycle time, to perform averaging so that, for example, the surface of the envelope and/or path envelope is averaged in areas, in particular in each surface, surface section and/or workpiece section, and/or only an average distance is maintained.

Laying out can also be performed by means of ray tracing, in which projection rays are fired at the workpiece, the envelope and/or path envelope starting from the beam or a line, which, especially in the case of round surfaces and/or cylindrical envelope surfaces, can also be a circular arc (section), whereby the projection rays are parallel to each other and/or directed towards a common point. Then, advantageously, the intersection points of the projection beams with the path envelope are determined and the respective path section is determined by these.

In particular, the laying/turning can be carried out in the direction of the, in particular, averaged normal on the, in particular, averaged surface, the surface section and/or workpiece section, the corresponding envelope and/or path envelope. This allows a uniform distribution of the path sections to be achieved.

The orientation of a tool axis of a robot tool, such as the average spraying direction of a spray gun, can, for example, be oriented in the direction of the turning direction, in particular the average and/or local turning direction present on the main spraying axis, and/or perpendicular to the respective sprayed surface of the workpiece, the envelope and/or path envelope. A further optimization, such as that known from Gleeson, would also be conceivable.

Advantageously, the robot path is created by connecting a plurality of robot path sections. This allows a continuous motion path to be obtained as a robot path, which can be further optimized, as known from Gleeson, for example.

A method according to one of the preceding claims in which the selection of a beam source, the beam direction and/or the beam spacing or the strategy for generating path sections is dependent on a selected painting strategy and/or is predetermined and/or is determined by a user input. The beam source determines in particular the location of the source.

In particular, the robot path is determined and/or the classification and/or the method is carried out by means of a data processing device, in particular comprising a CPU, memory, interface for robot control and/or output of the robot path, which may be further optimized, as known, for example, from Gleeson.

The neural network is advantageously one that has been trained using labelled data and/or in which the neural network is trained using labelled data, with the distinction between flat bodies or solid bodies for labelling the data is made on the basis of a predetermined limit of the volume/area and/or volume/volume ratio, whereby the (first) volume in particular is that of the workpiece and/or body and/or workpiece section, and the area is in particular the surface of the workpiece, the envelope and/or the body and/or workpiece section, in particular projected onto a plane, in particular a centre plane, and/or an, in particular, standard processing area and/or squared processing width of a/the robot/tool at a given time, and/whereby the second volume in the (first) volume/(second) volume ratio is determined in particular by multiplying an area and a width, wherein this area is in particular the surface of the workpiece, the envelope and/or the body and/or workpiece section, in particular projected onto a plane, in particular a center plane, and the width is in particular a processing width of a/the robot/tool at any given point in time. A predetermined limit is preferably set at 25 to 50% of the ratio of the volume of the workpiece and/or workpiece section to the product of processing width, in particular spraying width, and a plane, in particular a center plane, onto which the envelope is projected, whereby below this limit, a flat body is advantageously assumed.

The distinction between cubic and cylindrical is advantageously made on the basis of a predetermined value for the accumulated difference between the mean radius and the real radius in relation to the radius, wherein the radius is the radius around the main axis, and/or is determined by means of the mean radius of the envelope and a section plane through the envelope perpendicular to the main axis of the envelope, in which the area normals of the envelope deviate on average by more than a predetermined angle, in particular in the range from 10 to 45°, in particular 15 to 35°, from the main axis, where it is thereby determined whether the ratio of the distance of the plane reaches/exceeds a predetermined proportion, in particular in the range from 50 to 90%, in particular 60 to 85% of the mean radius to the section plane, reaches or falls below a predetermined proportion, in particular in the range of 50 to 100% of the processing width of the robot/tool. In the first case, a cylindrical body is advantageously assumed.

The distinction as to whether a shelf and/or a frame is involved, in particular in contrast to cubic and/or cylindrical, is advantageously made by determining whether the ratio of the connected volumes between the concave envelope and the convex envelope exceeds a predetermined limit value and/or by determining whether the workpiece, the surface of the workpiece section or surface section deviates from the convex envelope in such a way that there is at least one contiguous volume between them which, when projected perpendicularly onto a plane, in particular a center plane, is more than a predetermined multiple, in particular in the range of 1.1 to 3 times, of the processing surface and/or squared processing width of the robot/tool at a given point in time, and/or whose, in particular averaged, side surface normals deviate predominantly and/or completely by at least a predetermined value, in particular in the range of 35-55°, from the projection direction, in particular the center plane normal. In this case a shelf or frame is advantageously assumed.

The distinction between shelf and truss is advantageously made on the basis of the fact that the shelf has a base between the convex and the concave envelopes. The base is determined in particular by determining whether a surface closes the connected volume in the direction of the center plane and its normals deviate by less than a predetermined angle, in particular in the range of 35 to 55°, from the projection direction, in particular the center plane normal, and its area, in particular when projected in the projection direction, is greater than a predetermined multiple, in particular in the range of 1.1 to 3 times, of the processing area and/or squared processing width of the robot/tool at any given point in time. In this case a shelf and not a frame is advantageously assumed.

The distinction between a closed surface and a surface with a recess is advantageously made on the basis of whether the surface has at least a predetermined number of holes and/or at least one hole with a size above a predetermined size. The predetermined size is thereby dictated in particular by a limit for the ratio between, in particular on a plane, in particular a center plane and/or, in particular, an averaged tangential area at the edge of the hole divided by the maximum extension of the hole. The limit is thereby in particular a predetermined proportion of the processing width of the robot/tool at a given point in time, in particular in the range of 20 to 75%, in particular 25 to 50%. If the limit is exceeded, an area or a body with a recess is advantageously assumed.

A point in time is understood to be, in particular, a usual point in time for processing, and the processing width or area is understood to be, in particular, the width or area that is usually processed at the same time.

As an alternative to classification using a neural network, the aforementioned distinctions for labelling the training data can also be used directly for classifying the workpiece/envelope.

The painting strategies can, for example, be defined by rules or predetermined by previously defining path sections and/or, in particular, meandering paths, for example by manual teaching, in particular per classification class. Such predetermined strategies can also be adapted to varying sizes according to the size differences.

The painting strategy for surfaces is advantageously characterized by parallel path sections and/or at least one, in particular one or two, meandering paths, in particular rotated vertically and/or at 90° to each other, and/or for solid bodies by separate planning for the, in particular one or two, end faces and the side face(s), whereby in the case of recesses, the recesses are in particular recessed from the path sections above them, with the recesses being in particular considered individually as such if they each satisfy the above-mentioned condition. The path sections are recessed in particular in the area of the recess projected onto the envelope and/or path envelope, in particular in the direction of the normals on the plane of the hole, the envelope and/or path envelope, in particular the surface and/or the workpiece section and/or surface section, averaged in particular over the edge of the hole.

In particular, only planes, spheres, rotational ellipsoids and/or cylindrical surfaces are considered to be surface sections. These are determined in particular by averaging of and/or fitting to the envelope and/or path envelope and/or by averaging the workpiece and/or fitting to the workpiece or sections thereof.

Even if parts of the path sections are blanked out, it is possible that such a blanking is reversed by connecting the path sections.

The painting strategy for surfaces is advantageously determined by parallel path sections and/or at least one, in particular one or two meandering path(s), in particular perpendicular to each other and/or rotated by 90° to each other, wherein in the case of surfaces with recesses, the recesses are in particular blanked out from the path sections above them and/or for cubic surfaces, are planned separately on the side surfaces and end faces with path sections that are parallel to each other and/or parallel to the averaged respective surface and/or straight, in particular with at least one, in particular one or two, meandering path sections per side in particular perpendicular to each other and/or rotated by 90° to each other, and/or for cylindrical path sections are planned parallel to the main axis on a lateral surface and/or perpendicular to the main axis circularly around the workpiece and, in particular, at least one, in particular two, end face(s) separately with parallel and/or parallel to the averaged end face surface and/or straight path sections, in particular one or two, in particular, meandering path sections that are perpendicular to each other and/or rotated by 90° per end face, and/or for a frame and/or shelf, such as a cubic body, but with a different method for areas with contiguous volume that fulfils at least one of the above-mentioned conditions, with regard to their side surfaces, in particular by means of region growing based on normals or based on four spatial directions, in particular perpendicular to the projection direction, and planned separately with parallel path sections and/or meandering paths, whereby in the case of shelves, the base is also preferably planned with parallel path sections and/or meandering paths, and preferably the edge between the side surfaces and the base, in particular the surrounding edge, can also be planned separately with a surrounding path section.

A section plane of the envelope is used in particular as the face surface.

Advantageously, the data processing system generates a plurality of path sections for a first set of object surface, envelope surface and/or path envelope surface, in particular automatically, and in particular, assembles them into a preliminary continuous motion path, and, in particular, a real or virtual robot is used to process by means of the robot, in particular paint, either in reality or virtually, in particular by the robot travelling along the motion path, and for a second set of object surfaces that is smaller than the first set, at least one continuous manual motion path is generated by manual teaching, in particular manual control of a virtual or real robot, or by manually drawing and/or modifying and/or supplementing the automatically generated continuous motion path and/or path sections.

As a particular advantage, the processing or painting forms part of the method.

The object is also achieved by methods for processing, in particular painting, a plurality of identically shaped workpieces, wherein in particular automatically, a data processing system generates a plurality of path sections for a first set of object surfaces, in particular as described above, and in particular these are assembled into a preliminary continuous motion path, and in particular a real or virtual robot is used to have the robot paint in reality or virtually, and for a second set of object surfaces that is smaller than the first set, at least one continuous manual motion path is generated by manually controlling a virtual or real robot or by manually drawing of at least one continuous manual motion path and
the at least one manual motion path is used to supplement the automatic motion paths and/or to replace part of the automatically generated path sections, whereby at least two connection points are selected in the automatically generated path sections, in particular from the start and end points of the automatically generated path sections, in particular those which, in terms of distance and/or direction, deviate as little as possible from the start or end point of the continuous motion path or from a manual motion path section taken from it, and
a continuous robot path is determined which contains the non-replaced automatically generated path sections and the at least one manually generated motion path, and in particular this continuous motion path is used to control the robot for the actual painting.

The teaching process can also be carried out without the use of a robot, solely by detecting a movement, for example that of a hand-held tool and/or of a detection device.

The movement of a manually controlled robot can thereby be detected, for example, by tracking, for example based on optical detection, camera-based, using markers and/or using inertia sensors. The camera can also be attached to the robot and/or tool as a detection device or can track the detection device, the robot and/or its/the tool from a stationary position.

This continuous manual motion path can be used, for example, to change the movement of the robot at certain points and/or to supplement the processing with further processing operations.

The at least one manual motion path is used in particular to supplement the automatic motion paths and/or to replace part of the automatically generated path sections, whereby at least two connection points are selected for this purpose, in particular iteratively for each manual motion path and/or each path section shared in this way, in the automatically generated path sections and in particular the manual motion paths already processed in the iterative method and/or paths taken from such divided path sections, which can also be inverted in their direction of motion, where possible, in particular from the start and end points of the automatically generated path sections, in particular those which, in terms of distance and/or direction (which can also be considered inverted for this purpose) and/or tool orientation, exhibit the smallest possible deviation from the start or end of the continuous motion path or from a manual motion path section taken from it.

In particular a continuous robot path is determined which contains the non-replaced automatically generated path sections and the at least one manually generated motion path, and in particular this continuous robot path, if necessary after further optimization as known, for example, from Gleeson, is used to control the/a, in particular real, robot, for real painting.

In general, the robot path, possibly after further optimization, such as known, for example, from Gleeson, is advantageously used, in particular repeatedly, to control a robot for processing the/one workpiece in each case.

The data processing system can, in particular, comprise a CPU, working memory and read-only memory. It has in particular input and/or output means and/or an interface to a robot controller, in particular a PLC. In particular a program is stored on the read-only memory that is designed to perform a method according to the invention when executed by means of the CPU.

The method advantageously comprises the three steps of classification, strategy determination and path generation.

In order to determine the joining of path sections to form a robot path, at least one determination, in particular a plurality of determinations, of cycle time estimates is performed and/or, in particular, time and labor are invested for possible connections, and connections are selected by comparing the labor and/or cycle time estimates, which have the lowest possible cycle time/labor for the resulting robot path, wherein the cycle time or labor is determined in particular by the properties of the robot, in particular including the tool contained therein, and in particular times for translation and rotation of the robot, in particular the tool, such as a paint spray gun and/or abrasive and/or abrasive carrier, are determined for example by means of simulation of the movement of the robot and/or using algorithms from graph theory, such as the travelling salesman algorithm.

A robot path, at least one path section and/or the at least one manually generated motion path and/or at least one path section taken from it is advantageously optimized in such a way that its distance from the envelope, and/or from the workpiece is kept constant over its course, in particular by averaging it, and/or the course runs parallel to edges of the workpiece and/or of the envelope and/or path envelope and/or other path sections, in particular by defining a constant distance, in particular obtained from averaging, and/or the alignment of the tool, in particular the spray gun of the robot, is optimized and/or standardized, in particular in relation to the orientation of the normals of the envelope and/or path envelope and/or surface and/or surface section and/or averaged, in particular by means of reinforcement learning and/or simulated annealing and/or other stochastic optimization methods, whereby in particular a reward function is used which takes into account the aforementioned properties and/or rewards maintaining a constant aforementioned distance and/or aforementioned orientation and/or in particular punishes larger deviations (e.g. determined by means of chamfer distance) from the manually created motion path, the automatically generated path sections and/or the generated robot path and/or whereby the reward function is improved and/or learned based on a knowledge database of robot paths for processing a plurality of workpieces.

### BRIEF DESCRIPTION OF THE DRAWINGS

A treatment/characterization of a cylindrical body is described below, purely as an example and without limitation, using the purely illustrative figures.

FIG. 1 (FIG. 1) is a side projection of an envelope of a cylindrical body.

FIG. 2 (FIG. 2) is a view of an end face.

### DETAILED DESCRIPTION

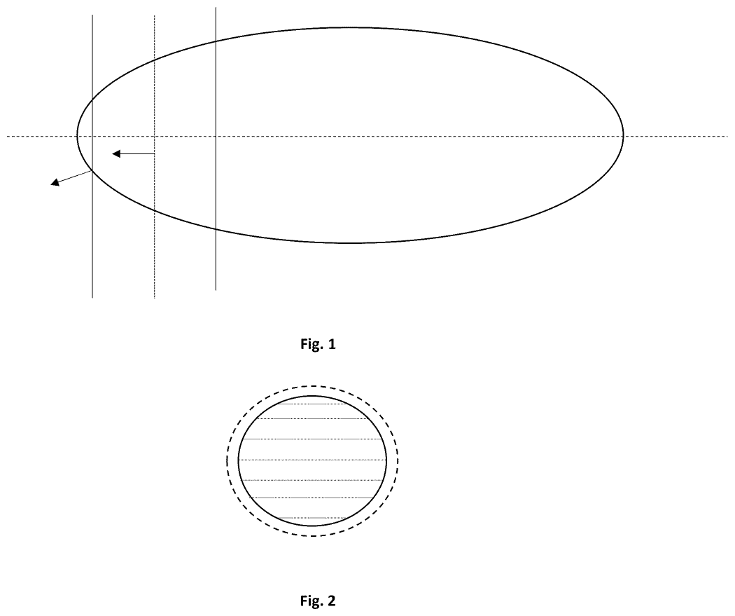

FIG. 1 shows a side projection of the envelope of a cylindrical body with the main axis running from left to right and extended over the envelope. The section plane of the average diameter perpendicular to the main axis is drawn as a solid line, and the normal to it is shown as an arrow. To the left of this, the section plane perpendicular to the main axis is shown as a dotted line, where the normal at the intersection of the envelope with this section plane deviates on average by 20° from the main axis. A normal is shown as an arrow for illustrative purposes. To the right of this, the section plane with the intersection with the envelope over an average of 75% of the maximum circumference is shown as a dotted line. The distance between the dotted lines can be used as a measure for distinguishing between cylindrical and cubic bodies.

FIG. 2 shows a view of an end face with path sections shown as dotted lines and a dotted line around it illustrating the course of the path sections for processing the outer surface.

What is claimed is:

1. A method for processing at least one workpiece wherein at least two surface sections of the workpiece are classified by a neural network into at least one classification and, based on the classification, a predetermined painting strategy is selected for each surface section of the at least two surface sections and used to generate a robot path, wherein the classification distinguishes at least between flat bodies and solid bodies on the one hand, and between closed bodies or those with recesses on the other.

2. The method according to claim 1 for processing a plurality of identically shaped workpieces, comprising:
a first step, wherein at least one robot path is created based on a digital model of the workpieces or a first scan of the workpieces, wherein a convex envelope or concave envelope of a point cloud is determined and wherein the at least one robot path is created using the envelope;
a second step, wherein a point cloud of an outer contour of a second workpiece is created by a 3D scanner or the 3D scanner;
wherein a position and an orientation of the digital model, is compared to determine a translational or rotational positional difference of a workpiece of the plurality of workpieces or at least one of its surfaces, at least two workpiece sections or at least two surface sections, and the robot path is transformed by a positional difference, and the transformed robot path is traversed by at least one robot for processing the second workpiece.

3. The method according to claim 1, wherein the processing is painting or the classification is performed using PointNet or PointNet++ or on a point basis.

4. The method according to claim 1, wherein a painting strategy is used to generate at least two path sections for generating the at least one robot path, or wherein a distinction is made between closed surfaces, surfaces with recesses, cubic, cylindrical, shelf-shaped bodies and frame bodies.

5. The method according to claim 1, wherein a consolidation of a point-based classification into at least two workpiece sections or at least two surface sections with a minimum size of a machining radius of simultaneous processing of a robot is performed, region-based or by segmentation or by clustering.

6. The method according to claim 2, wherein the second step is repeated with further workpieces of the plurality of workpieces or wherein the envelope is determined by Delaunay triangulation or by 3D alpha wrapping.

7. The method according to claim 1, wherein the at least one robot path is generated as at least two path sections that are connected to each other, with the at least two path sections being laid as straight lines in two directions on a path envelope at a predetermined distance from the envelope, or wherein the at least one robot path is created by connecting a plurality of path sections.

8. The method according to claim 7, wherein the at least two path sections are created by laying or deflecting beams onto the envelope or wherein the choice of a beam source, the beam direction or the beam spacing or the strategy for generating path segments depends on a selected painting strategy.

9. The method according to claim 1, wherein a neural network is a network that has been trained using labelled data or wherein the neural network is trained on labelled data and the distinction between flat bodies and solid bodies for labelling the data is made on the basis of a predetermined limit of the volume/area ratio, or between cubic and cylindrical based on a predetermined value for the accumulated difference between the mean radius and the actual radius in relation to the radius, wherein a radius is a radius around a main axis, or wherein shelves or frames are characterized by the fact that the ratio of the connected volumes between the concave envelope and the convex envelope exceeds a predetermined limit value, or wherein shelves and frames differ in that the shelf has a base below the volume between convex and concave envelope, or the distinction between a closed surface and a surface with a recess depends on whether at least one hole with a size above a predetermined size is present.

10. The method according to claim 1, wherein a painting strategy for surfaces comprises:
at least two parallel path sections or at least one meandering path, or for solid bodies by separate planning for the end faces and the side face(s), or wherein in the case of recesses, the recesses are recessed.

11. The method according to claim 1, wherein a painting strategy for surfaces comprises:
at least two parallel path sections or at least one meandering path or wherein in the case of surfaces with recesses, the recesses are recessed from the path sections above them, or for cubic surfaces, are planned separately on the side surfaces and end surfaces with path sections that are parallel to each other or parallel to the averaged respective surface or straight path sections, or for cylindrical path sections parallel to a main axis, they can be placed on a lateral surface or perpendicular to the main axis in a circular pattern around the workpiece, or a front side can be planned separately with path sections that are parallel to each other or parallel to the cantered front side surface or straight path sections, or for a frame or shelf as a cubic body but with a different procedure for the areas with volumes between the concave envelope and the convex envelope above a predetermined limit value, side surfaces are determined, or by means of region growing based on the normals or four spatial directions, and are provided separately with parallel path sections or meandering paths, or, in the case of shelves, the base is also planned with parallel path sections or meandering paths, or the edge between the side surfaces and the base is planned separately with a circumferential path section.

12. A method for processing a plurality of identically shaped workpieces, wherein a data processing system generates a plurality of path sections for a first set of object surfaces or combines a plurality of path sections for a first set of object surfaces into a preliminary continuous motion path, and a real or virtual robot is used to paint really or virtually by the robot, and for a second set of object surfaces that is smaller than the first set, at least one continuous manual motion path is generated by manually controlling a virtual or real robot or by manually drawing of at least one continuous manual motion path;
wherein an at least one manually motion path is used to supplement an automatically generated path segments or the at least one continuous motion path or to replace a part of the automatically generated path segments or at least one continuous motion path, wherein at least two connection points are selected in the automatically generated path sections or the at least one continuous motion path; and
a continuous robot path is determined which contains a non-replaced automatically generated path sections or parts of the at least one continuous motion path and the at least one manually generated motion path.

13. The method according to claim 12, wherein the at least two connection points in the automatically generated path sections or the at least one continuous motion path are selected from a start point and an end point of the automatically generated path sections or are selected as those which, in terms of distance or direction, deviate as little as possible from a start point or an end point of the at least one continuous manual motion path or to a manual motion path section taken from it.

14. The method according to claim 12, wherein the at least one continuous motion path is used to control the robot for real painting.

15. The method according to claim 12, wherein the at least one manual motion path is recorded by a tracked teach tool or wherein the at least one manual motion path is recorded by an attachment attached to a hand-held paint spray gun, wherein the movement of the hand-held paint spray gun is recorded via the attachment by a camera-based system that is detached and remote from the attachment.

16. The method according to claim 15, wherein the movement of the hand-held paint spray gun is detected via the attachment exclusively by reflector marks on the attachment, or the attachment has IMU or LED marks that are used for detection.

17. The method according to claim 12, wherein the manual motion path is optimized and, in order to optimize the detected manual motion path, points of the detected manual motion path are removed or replaced by points of the linearized path using a multidimensional Douglas Peuker algorithm, with a maximum predetermined vector deviation in translation, rotation or velocity, or are replaced by points of the linearized path.

18. The method according to claim 12, wherein at least two threshold values for at least two specified deviations for translation, rotation and speed can be specified independently of one another or includes the simulation of a recorded or recorded and optimized manual motion path for the detection of singularities and non-feasibilities of the robot implementing the motion path.

19. The method according to claim 12, wherein manual painting is possible or is performed during the detection of the manual motion path, wherein an on on/off signal of the spraying process is detected, or wherein parameters influencing the spray cone or the air pressure of the gas driving the spraying process are detected, or includes the resolution of singularities and non-feasibilities of the motion path by a specified robot by varying translational and rotational values of the motion path within specified limits in order to achieve the resolution.

20. The method according to claim 12, wherein the continuous robot path or an optimized robot path is used to control a robot for processing the workpiece, or in which the method includes the three steps of classification, strategy determination and path generation.

21. The method according to claim 1, wherein in order to determine the connections of path sections to a robot path, an estimation of cycle time or time and labor for possible connections is made, and connections with the lowest possible cycle time/labor are selected by comparing the labor involved.

22. The method according to claim 21, wherein the cycle time or labor is determined by the properties of the robot, including the tool contained therein, or includes times for translation and rotation of the robot or its tool or its paint gun or its abrasive.

23. The method according to claim 22, wherein the estimation is performed by means of simulation or algorithms from graph theory or the travelling salesman algorithm.

24. The method according to claim 12, wherein the at least one manually generated motion path or at least one path section taken from it is optimized by keeping its distance from the envelope constant over its course or by laying the course parallel to edges of the workpiece, or by specifying a constant distance obtained by averaging, or the alignment of the tool is optimized or standardized, or the alignment of the tool in relation to the normal of the envelope is optimized or standardized or averaged.

25. The method according to claim 24, wherein the optimization is performed by reinforcement learning or simulated annealing in which a reward function is used which rewards keeping the distance and/or orientation to the surface constant or penalizes deviations (e.g. chamfer distance) from the manually created motion path, or in which the reward function is improved or learned based on a knowledge database of robot paths for processing a plurality of workpieces.
